(19) United States
(12) Patent Application Publication
(10) Pub. No.: US 2025/0141986 A1
(43) Pub. Date: May 1, 2025

(54) MOBILE TERMINAL PROVIDED WITH DAMPING STRUCTURE

(71) Applicant: LG ELECTRONICS INC., Seoul (KR)

(72) Inventors: Dongjun CHOI, Seoul (KR); Seungkyu PARK, Seoul (KR); Deung HWANGBO, Seoul (KR); Sunha PARK, Seoul (KR); Minkyu OH, Seoul (KR); Youngjee SON, Seoul (KR); Sung Gul HWANG, Seoul (KR)

(73) Assignee: LG ELECTRONICS INC., Seoul (KR)

(21) Appl. No.: 18/726,046

(22) PCT Filed: Jun. 15, 2022
(86) PCT No.: PCT/KR2022/008474

§ 371 Date: Jul. 1, 2024

(30) Foreign Application Priority Data
Feb. 22, 2022 (KR) 10-2022-0023254

(51) Int. Cl. H04M 1/02

(52) U.S. Cl. CPC H04M 1/0237; H04M 1/0268

(57) ABSTRACT

The present invention comprises: a first frame; a second frame coupled to the first frame so as to be slidable in a first direction or in a second direction opposite to the first direction; and a damper coupled to the first frame. The second frame includes a damping strip extending in the first direction. In case where the size of a display (151) of a mobile terminal, which is in contact with the damper in at least a partial section, when the second frame slides, is manually extended or contracted, the damping strip can stably slide by adjusting the speed thereof at a position corresponding to a designated inch.

### TECHNICAL FIELD

The present disclosure relates to a mobile terminal, and more particularly, to a mobile terminal having a flexible display slidable to extend a size of a screen.

### BACKGROUND ART

Terminals may be generally classified as mobile/portable terminals or stationary terminals according to their mobility. Mobile terminals may also be classified as handheld terminals or vehicle mounted terminals according to whether or not a user can directly carry the terminal.

A display device is a device having a function of receiving, processing, and displaying an image that can be viewed by a user. For example, the display device receives a broadcast selected by a user from broadcast signals transmitted from a broadcasting station, separates an image signal from the received signal, and displays the separated image signal on a display.

With the development of broadcasting technologies and network technologies, functions of a display device have been significantly diversified, and the performance of the device has been improved accordingly. That is, the display device has been developed to provide not only broadcast contents but also various other contents to a user. For example, a display device may provide game play, music appreciation, internet shopping, user customized information, and the like using various applications as well as programs received from a broadcasting station. To perform such an extension function, the display device may basically be connected to other devices or networks using various communication protocols, and may provide a user with ubiquitous computing environment. That is, the display device is advanced to a smart device that enables connectivity to the network and ubiquitous computing.

Recently, a flexible display capable of large deformation with sufficient elasticity has been developed. A size of a mobile terminal can be varied using the deformation property of the flexible display. The mobile terminal of such a variable structure needs to stably change a size of its own, and a structure for supporting the extended display unit to maintain a flat surface is required.

A size-variable structure may be implemented by sliding a pair of frames. The movement of a pair of the frames may be configured to be automatically driven by using an electromotive device such as a motor, or a user may manually extend or retract the frames.

### DISCLOSURE

### Technical Tasks

One technical task of the present disclosure is to provide a mobile terminal capable of improving the durability of a flexible display unit by not limiting a point where a flexible display unit is bent to a specific position.

Another technical task of the present disclosure is to provide a mobile terminal capable of stable and slidable movement when a display size is manually increased/decreased.

### Technical Solutions

In one technical aspect of the present disclosure, provided is a mobile terminal including a first frame, a second frame coupled to the first frame to slide in a first direction or a second direction opposite to the first direction, and a damper coupled to the first frame, wherein the second frame may include a damping strip extending in the first direction and wherein the damping strip may contact the damper in a partial section at least when the second frame slides.

The damper may include a rotary damper rotatably coupled to the first frame and the damper may rotate according to a sliding movement of the first frame when contacting the damping strip.

The damping strip may include a deceleration section having a contact protrusion protruding in a third direction vertical to the first direction and an acceleration section having the contact protrusion not formed therein, and the rotary damper may include a first rotary damper located in the third direction of the damping strip, spaced apart from the damping strip in the acceleration section, and rotating by contacting the contact protrusion in the deceleration section.

The rotary damper may include a second rotary damper positioned in a fourth direction opposite to the third direction of the damping strip and the second rotary damper may maintain a contact state with the damping strip when the second frame slides.

The first rotary damper may include a first pinion gear having sawteeth formed on an outer circumferential surface thereof and the damping strip may include a rack gear having first linear sawteeth formed at a position related to the contact protrusion to engage with the sawteeth of the pinion gear.

The rack gear may include second linear sawteeth continuously formed in a fourth direction opposite to the third direction and the pinion gear may include a second pinion gear positioned in the fourth direction of the rack gear to rotate by engaging with the second linear sawteeth.

The deceleration section may include a position having the second frame fixed thereat.

The mobile terminal may include a locking device configured to fix a first state of a maximum overlapping area between the second frame and the first frame and an elastic part located at one side of the first frame or the second frame to be compressed in the first state or extended upon releasing the locking device.

The locking device may include a first latch part positioned in the first frame, a second latch part positioned in the second frame to engage with the first latch part, and an unlock button exposed to an outside of the first frame to separate the first latch part from the second latch part.

The mobile terminal may include a flexible display having a fixed region coupled to the first frame and a variable region located in the first direction of the fixed region and extending in a rear direction while surrounding the second frame, and an area of the variable region located on a front surface may vary depending on a position of the second frame.

### Advantageous Effects

A mobile terminal of the present disclosure may adjust a size of a screen as necessary, thereby satisfying both portability and usability.

In addition, a mobile terminal of the present disclosure may provide a mobile terminal capable of manually increasing/decreasing a display size.

In addition, a mobile terminal of the present disclosure may perform stable and slidable movement by adjusting a speed at a position corresponding to a designated inch when a display size is manually increased or decreased.

In addition, elasticity of an elastic part may be used to assist a force upon extending, and a first frame and a second frame may be stably fastened without colliding with each other upon retracting.

Further scope of applicability of the present disclosure will become apparent from the detailed description given hereinafter. However, it should be understood that the detailed description and specific examples, while indicating preferred embodiments of the invention, are given by illustration only, since various changes and modifications within the spirit and scope of the disclosure will become apparent to those skilled in the art from this detailed description.

### DESCRIPTION OF DRAWINGS

FIG. 1 is a block diagram to describe a mobile terminal.

FIG. 2 and FIG. 3 are diagrams illustrating a per-inch state of a display of a mobile terminal according to an embodiment.

FIG. 4 is an exploded diagram illustrating a mobile terminal according to an embodiment.

FIG. 5 is a diagram illustrating a cross-sectional view taken along line A-A of FIG. 2.

FIG. 6 is a diagram illustrating a cross-sectional view taken along line B-B of FIG. 3.

FIG. 7 is a diagram illustrating an elastic spring of a mobile terminal according to an embodiment.

FIG. 8 is a diagram illustrating a damping structure of a mobile terminal according to an embodiment.

FIG. 9 is a diagram illustrating a damping structure of a mobile terminal according to another embodiment.

### BEST MODE

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be directly connected with the other element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

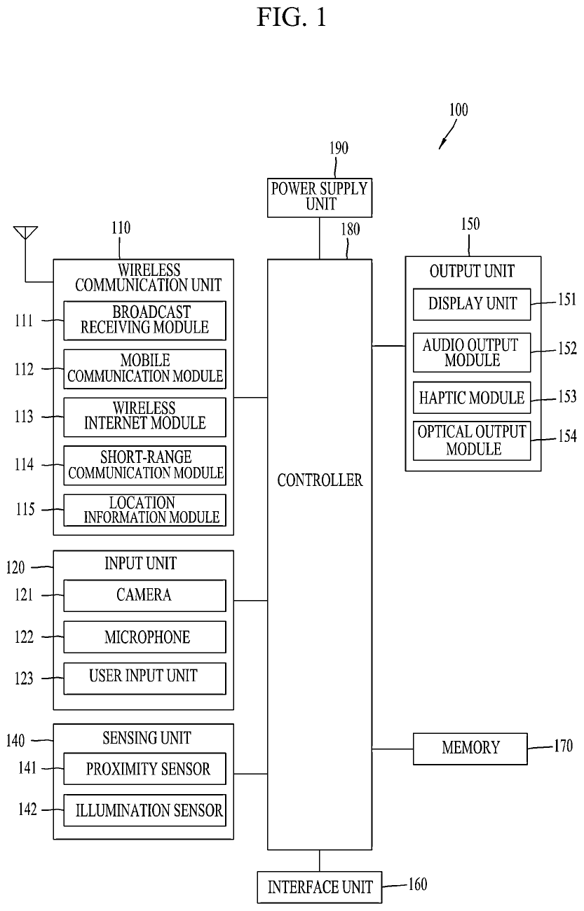

FIG. 1A is a block diagram of a mobile terminal in accordance with the present disclosure.

The mobile terminal 100 is shown having components such as a wireless communication unit 110, an input unit 120, a sensing unit 140, an output unit 150, an interface unit 160, a memory 170, a controller 180, and a power supply unit 190. It is understood that implementing all of the illustrated components in FIG. 1 is not a requirement, and that greater or fewer components may alternatively be implemented than the components listed above.

More specifically, the wireless communication unit 110 typically includes one or more modules which permit communications such as wireless communications between the mobile terminal 100 and a wireless communication system, communications between the mobile terminal 100 and another mobile terminal, communications between the mobile terminal 100 and an external server. Further, the wireless communication unit 110 typically includes one or more modules which connect the mobile terminal 100 to one or more networks.

To facilitate such communications, the wireless communication unit 110 includes one or more of a broadcast receiving module 111, a mobile communication module 112, a wireless Internet module 113, a short-range communication module 114, and a location information module 115.

Regarding the wireless communication unit 110, the broadcast receiving module 111 is typically configured to receive a broadcast signal and/or broadcast associated information from an external broadcast managing entity via a broadcast channel. The broadcast channel may include a satellite channel, a terrestrial channel, or both. In some embodiments, two or more broadcast receiving modules 111 may be utilized to facilitate simultaneously receiving of two or more broadcast channels, or to support switching among broadcast channels.

The mobile communication module 112 can transmit and/or receive wireless signals to and from one or more network entities. Typical examples of a network entity include a base station, an external mobile terminal, a server, and the like. Such network entities form part of a mobile communication network, which is constructed according to technical standards or communication methods for mobile communications (for example, Global System for Mobile Communication (GSM), Code Division Multi Access (CDMA), CDMA2000 (Code Division Multi Access 2000), EV-DO (Enhanced Voice-Data Optimized or Enhanced Voice-Data Only), Wideband CDMA (WCDMA), High Speed Downlink Packet access (HSDPA), HSUPA (High Speed Uplink Packet Access), Long Term Evolution (LTE), LTE-A (Long Term Evolution-Advanced), and the like).

Examples of wireless signals transmitted and/or received via the mobile communication module 112 include audio call signals, video (telephony) call signals, or various formats of data to support communication of text and multimedia messages.

The wireless Internet module 113 is configured to facilitate wireless Internet access. This module may be internally or externally coupled to the mobile terminal 100. The wireless Internet module 113 may transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), HSUPA (High Speed Uplink Packet Access), Long Term Evolution (LTE), LTE-A (Long Term Evolution-Advanced), and the like. The wireless Internet module 113 may transmit/receive data according to one or more of such wireless Internet technologies, and other Internet technologies as well.

In some embodiments, when the wireless Internet access is implemented according to, for example, WiBro, HSDPA,HSUPA, GSM, CDMA, WCDMA, LTE, LTE-A and the like, as part of a mobile communication network, the wireless Internet module 113 performs such wireless Internet access. As such, the Internet module 113 may cooperate with, or function as, the mobile communication module 112.

The short-range communication module 114 is configured to facilitate short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like. The short-range communication module 114 in general supports wireless communications between the mobile terminal 100 and a wireless communication system, communications between the mobile terminal 100 and another mobile terminal 100, or communications between the mobile terminal and a network where another mobile terminal 100 (or an external server) is located, via wireless area networks. One example of the wireless area networks is a wireless personal area networks.

The location information module 115 is generally configured to detect, calculate, derive or otherwise identify a position of the mobile terminal. As an example, the location information module 115 includes a Global Position System (GPS) module, a Wi-Fi module, or both. If desired, the location information module 115 may alternatively or additionally function with any of the other modules of the wireless communication unit 110 to obtain data related to the position of the mobile terminal. As one example, when the mobile terminal uses a GPS module, a position of the mobile terminal may be acquired using a signal sent from a GPS satellite. As another example, when the mobile terminal uses the Wi-Fi module, a position of the mobile terminal can be acquired based on information related to a wireless access point (AP) which transmits or receives a wireless signal to or from the Wi-Fi module.

The input unit 120 includes a camera 121 for obtaining images or video, a microphone 122, which is one type of audio input device for inputting an audio signal, and a user input unit 123 (for example, a touch key, a push key, a mechanical key, a soft key, and the like) for allowing a user to input information. Data (for example, audio, video, image, and the like) is obtained by the input unit 120 and may be analyzed and processed as a user's control command.

The cameras 121 may process image frames of still pictures or video obtained by image sensors in a video or image capture mode. The processed image frames can be displayed on the display unit 151 or stored in memory 170. In some cases, the cameras 121 may be arranged in a matrix configuration to permit a plurality of images having various angles or focal points to be input to the mobile terminal 100. As another example, the cameras 121 may be located in a stereoscopic arrangement to acquire left and right images for implementing a stereoscopic image.

The microphone 122 is generally implemented to permit audio input to the mobile terminal 100. The audio input can be processed in various manners according to a function being executed in the mobile terminal 100. If desired, the microphone 122 may include assorted noise removing algorithms to remove unwanted noise generated in the course of receiving the external audio.

The user input unit 123 is a component that permits input by a user. Such user input may enable the controller 180 to control operation of the mobile terminal 100. The user input unit 123 may include one or more of a mechanical input element (for example, a key, a button located on a front and/or rear surface or a side surface of the mobile terminal 100, a dome switch, a jog wheel, a jog switch, and the like), or a touch-sensitive input, among others. As one example, the touch-sensitive input may be a virtual key or a soft key, which is displayed on a touch screen through software processing, or a touch key which is located on the mobile terminal at a location that is other than the touch screen. On the other hand, the virtual key or the visual key may be displayed on the touch screen in various shapes, for example, graphic, text, icon, video, or a combination thereof.

The sensing unit 140 is typically implemented using one or more sensors configured to sense internal information of the mobile terminal, the surrounding environment of the mobile terminal, user information, and the like. For example, the sensing unit 140 may alternatively or additionally include other types of sensors or devices, such as a proximity sensor 141 and an illumination sensor 142, a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few. The mobile terminal 100 may be configured to utilize information obtained from sensing unit 140, and in particular, information obtained from one or more sensors of the sensing unit 140, and combinations thereof.

The output unit 150 is typically configured to output various types of information, such as audio, video, tactile output, and the like. The output unit 150 is shown having a display unit 151, an audio output module 152, a haptic module 153, and an optical output module 154. The display unit 151 may have an inter-layered structure or an integrated structure with a touch sensor in order to facilitate a touch screen. The touch screen may provide an output interface between the mobile terminal 100 and a user, as well as function as the user input unit 123 which provides an input interface between the mobile terminal 100 and the user.

The audio output module 152 is generally configured to output audio data. Such audio data may be obtained from any of a number of different sources, such that the audio data may be received from the wireless communication unit 110 or may have been stored in the memory 170. The audio data may be output during modes such as a signal reception mode, a call mode, a record mode, a voice recognition mode, a broadcast reception mode, and the like. The audio output module 152 can provide audible output related to a particular function (e.g., a call signal reception sound, a message reception sound, etc.) performed by the mobile terminal 100. The audio output module 152 may also be implemented as a receiver, a speaker, a buzzer, or the like.

A haptic module 153 can be configured to generate various tactile effects that a user feels, perceive, or otherwise experience. A typical example of a tactile effect generated by the haptic module 153 is vibration. The strength, pattern and the like of the vibration generated by the haptic module 153 can be controlled by user selection or setting by the controller. For example, the haptic module 153 may output different vibrations in a combining manner or a sequential manner.

An optical output module 154 can output a signal for indicating an event generation using light of a light source. Examples of events generated in the mobile terminal 100 may include message reception, call signal reception, a missed call, an alarm, a schedule notice, an email reception, information reception through an application, and the like.

The interface unit 160 serves as an interface with various types of external devices that can be coupled to the mobile terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the mobile terminal 100 may perform assorted control functions associated with a connected external device, in response to the external device being connected to the interface unit 160.

The memory 170 is typically implemented to store data to support various functions or features of the mobile terminal 100. For instance, the memory 170 may be configured to store application programs executed in the mobile terminal 100, data or instructions for operations of the mobile terminal 100, and the like. Some of these application programs may be downloaded from an external server via wireless communication. Other application programs may be installed within the mobile terminal 100 at time of manufacturing or shipping, which is typically the case for basic functions of the mobile terminal 100 (for example, receiving a call, placing a call, receiving a message, sending a message, and the like). It is common for application programs to be stored in the memory 170, installed in the mobile terminal 100, and executed by the controller 180 to perform an operation (or function) for the mobile terminal 100.

The controller 180 typically functions to control overall operation of the mobile terminal 100, in addition to the operations associated with the application programs. The controller 180 may provide or process information or functions appropriate for a user by processing signals, data, information and the like, which are input or output, or activating application programs stored in the memory 170.

To drive the application programs stored in the memory 170, the controller 180 may be implemented to control a predetermined number of the components mentioned above in reference with FIG. 1A. Moreover, the controller 180 may be implemented to combinedly operate two or more of the components provided in the mobile terminal 100 to drive the application programs.

The power supply unit 190 can be configured to receive external power or provide internal power in order to supply appropriate power required for operating elements and components included in the mobile terminal 100. The power supply unit 190 may include a battery, and the battery may be configured to be embedded in the terminal body, or configured to be detachable from the terminal body.

Some or more of the components may be operated cooperatively to embody an operation, control or a control method of the mobile terminal in accordance with embodiments of the present disclosure. Also, the operation, control or control method of the mobile terminal may be realized on the mobile terminal by driving of one or more application problems stored in the memory 170.

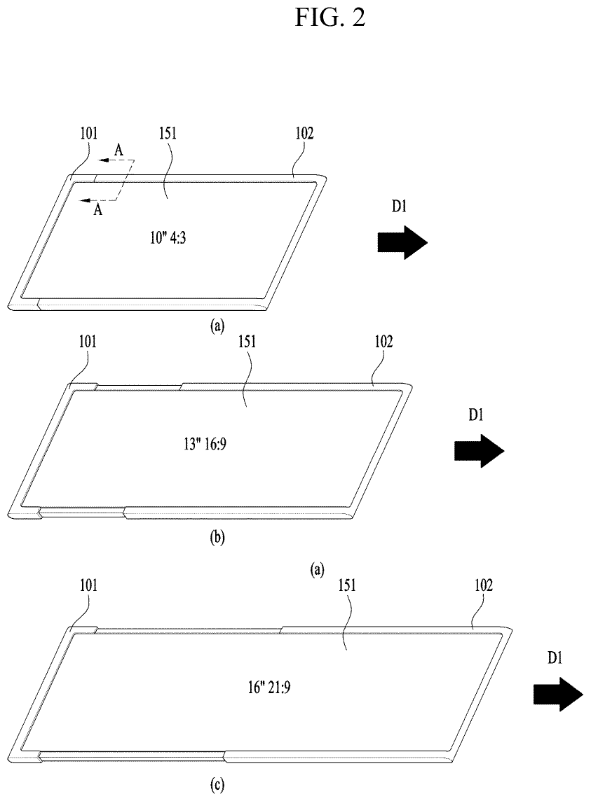

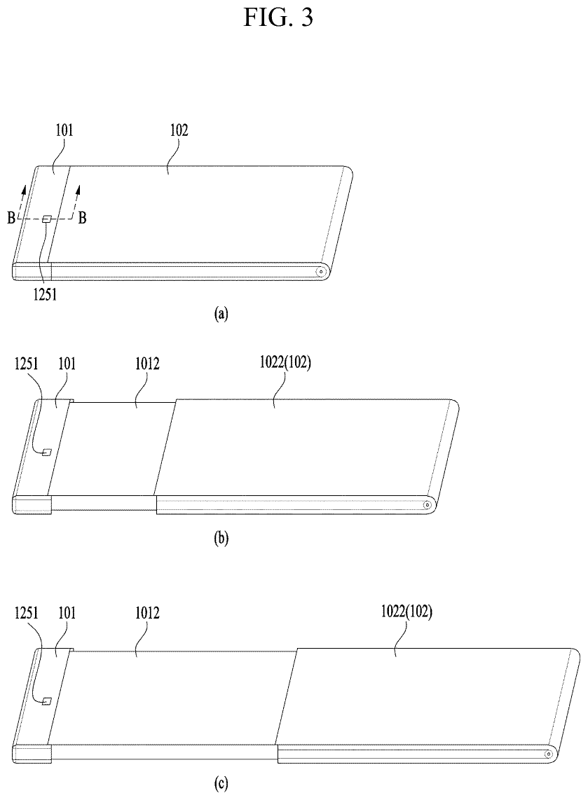

FIG. 2 and FIG. 3 are diagrams illustrating a per-inch state of a display 151 of a mobile terminal 100 according to an embodiment, and FIG. 4 is an exploded diagram illustrating the mobile terminal 100 according to an embodiment.

As shown in FIG. 2 and FIG. 3, the mobile terminal 100 of the present disclosure varies in size. A body extendable/retractable upon slidably moving includes a first frame 101 and a second frame 102 slidably moving with respect to the first frame 101.

The second frame 102 may be extended in case of moving in a first direction D1 with respect to the first frame 101, or may be retracted in case of moving in a second direction opposite to the first direction. A size of the mobile terminal 100 may vary depending on a movement distance of the second frame 102.

When a display 151 is provided in each of the first frame 101 and the second frames 102 overlapping the first frame 101 and the second frame 102 slides to move, the display 151 hidden in the first frame 101 may be exposed, but a flexible display 151 may be used to form a continuous screen.

A state in which an overlap amount between the first frame 101 and the second frame 102 is the largest, that is, a state in which the size of the mobile terminal 100 is the smallest, is referred to as a first state or a retracted state, and a state in which the second frame 102 moves in the second direction to increase in size is referred to as a second state or an extended state.

The flexible display 151 may include a fixed region 151a facing a front side irrespective of a state and a variable region 151b disposed on a front surface or a rear surface depending on a position of the second frame 102.

The variable region 151b may be disposed in a manner of surrounding the second frame 102. One portion of the variable region 151b may be positioned on the front surface and another portion of the variable region 151b may be disposed on the rear surface. An area of the front surface and the rear surface of the variable region 151b may vary depending on the position of the second frame 102. A curved part may be included between the front surface and the rear surface, and a position of the curved part may vary depending on the position of the second frame 102.

The extended state may be configured systematically. In each extended state, a length of a third direction, which is a vertical direction of the slide movement direction D1, is the same. Yet, as the length of the first direction changes, a screen ratio (i.e., an aspect ratio) may vary.

For example, as shown in FIG. 2, an aspect ratio may be 4:3 in a retracted state, a first extended state may have an aspect ratio of 16:9, and a second extended state may have an aspect ratio of 21:9.

As the display 151 is positioned on front surfaces of the first frame 101 and the second frame 102, an area of the display 151 varies depending on the sliding movement of the second frame 102. On rear surface, as shown in FIG. 3, a portion of the first frame 101 positioned inside the second frame 102 may be exposed.

The first frame 101 may include a first rear cover 1015 constituting a portion of the rear surface in an extended state so that components mounted inside the first frame 101 are not exposed to the outside. A second rear cover 1025 of the second frame 102 may be positioned on the rear surface of the first rear cover 1015, and a rear surface part of the variable region 151b of the display 151 may move to the front surface by moving from the front surface (inside) of the second rear cover in the first direction when the second frame 102 moves in the first direction.

Referring to FIG. 4, the first frame 101 may include a main frame 1012 forming a prescribed space to mount components therein and a first front part 1011 supporting a rear surface of the fixed region 151a of the display 151.

The first frame 101 may further include a first rear cover 1015 covering a rear surface of the main frame 1012 so that components mounted in the main frame 1012 are not exposed to the outside, and an exposed rear part 1013 constituting a portion of the rear surface of the mobile terminal 100 even in the retracted state.

At least one of a camera, an antenna, a user input unit, or an unlock button 1251 facing the rear surface may be disposed on the exposed rear part 1013. The exposed rear part 1013 may form the same plane with the second rear cover 1025 of the second frame 102 in the retracted state.

The first rear cover 1015 of the first frame 101 and the second rear cover 1025 of the second frame 102 may use an opaque material to cover the internal components.

The second frame 102 may include a second front part 1021 supporting the variable region 151b moving to the front surface. The second front surface part 1021 may be positioned on the rear surface of the first front part 1011 of the first frame 101. Then, the second front part 1021 may be withdrawn from the first front part 1011 when the second frame 102 is moved, thereby being positioned on the rear surface of the variable region 151b.

To fill a gap corresponding to the thickness of the first front part 1011, the rear surface of the variable region 151b of the display 151 may further include a rolling hinge (not shown) that is bendable in the first direction and provides a supporting force without being bent in the third direction.

The rolling hinge has a thickness corresponding to the thickness of the first front part 1011 and is positioned in the rear surface direction in the retracted state. When switching to the extended state, the rolling hinge may move between the second front part 1021 and the variable region 151b of the display 151.

The rear surface of the second frame 102 may further include a slide frame 1023 positioned on the front surface of the variable region 151b to support the variable region 151b of the display 151 positioned on the rear surface of the mobile terminal 100, and the third frame 103 positioned at an end portion of the variable region 151b of the display 151 may move in the first direction or the second direction along the slide frame 1023.

Since the third frame 103 moves in the first direction with respect to the second frame 102 in response to a distance that the second frame 102 has moved in the first direction with respect to the first frame 101, a moving distance of the third frame 103 is twice the second frame 102 with respect to the first frame 101.

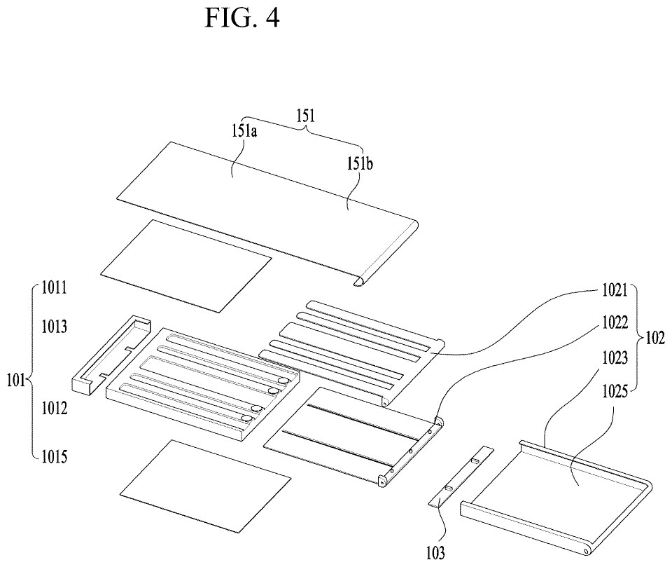

FIG. 5 is a cross-sectional diagram illustrating a view taken along a line A-A of FIG. 2. Each configuration of the first frame 101 and each configuration of the second frame 102 are disposed in a manner of overlapping each other and maintain an exterior in the extended state of the mobile terminal 100.

The first front part 1011 of the first frame 101 and the second front part 1021 of the second frame 102, which are positioned on the front surface with respect to the main frame 1012 on which the components of the first frame 101 are mounted, may be disposed in a manner of overlapping each other.

The slide frame 1023 of the second frame 102 positioned on the rear surface of the main frame 1012 may slide and move with respect to the first frame 101, and may include a guide part 105 that stably moves in the first direction or the second direction without being shaken upon sliding to move between the main frame 1012 and the slide frame 1023.

The guide part 105 may include a guide groove 1051 positioned in the main frame 1012 and a moving guide 1052 inserted into the guide groove 1051 to move. The moving guide 1052 may include a material having the same rigidity as the STS material, and the guide groove 1051 may include a Poly Oxy Methylene acetal (POM) material that is strong against friction.

The third frame 103 moving together with the variable region 151b of the display 151 may move on the rear surface of the slide frame 1023, and the third frame 103 of the second frame 102 may move between the slide frame 1023 and the second rear cover 1025.

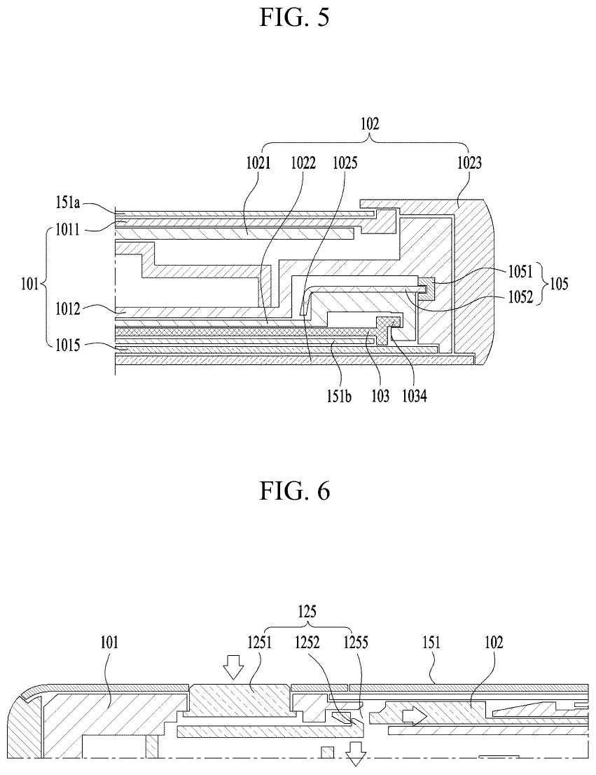

FIG. 6 is a cross-sectional diagram illustrating a view taken along line B-B of FIG. 3. Illustrated is a locking device 125 including an unlock button 1251 positioned at the exposed rear part 1013. The locking device 125 includes a first latch part 1252 positioned in the first frame 101, a second latch part 1253 positioned in the second frame 102 to be engaged with the first latch part 1252, and an unlock button 1251 exposed to the outside of the first frame 101 to separate the first latch part 1252 from the second latch part 1253.

The first latch part 1252 and the second latch part 1253 are fastened together by engaging with each other in the retracted state and restrict the sliding movement of the second frame 102. Since the first latch part 1252 is connected to the unlock button 1251, when a user presses the unlock button 1251, the first latch part 1252 is separated from the second latch part 1253, thereby releasing the fixed state of the first frame 101 and the second frame 102.

In this case, an elastic part 210 may be further included to provide a force of pushing the second frame 102 in the first direction to prevent the first latch part 1252 from being re-fastened to the second latch part 1253 when the first latch part 1252 returns to the original position by removing the force pressing the unlock button 1251.

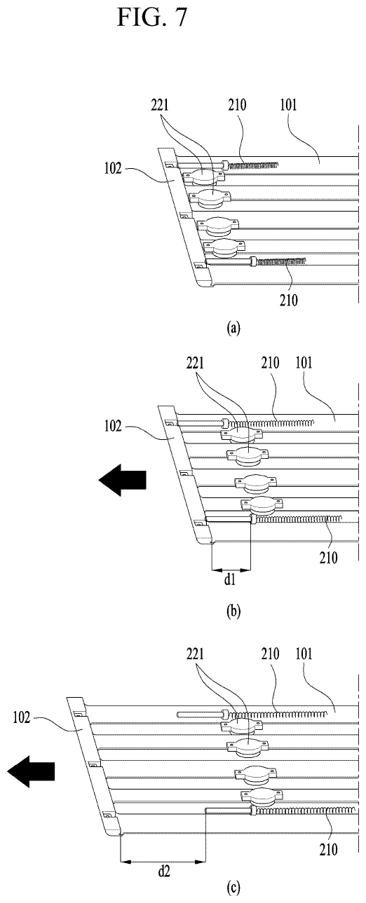

FIG. 7 is a diagram illustrating an clastic spring of the mobile terminal 100 according to an embodiment. An elastic spring may be used as the elastic part 210 and may be coupled to one side of the first frame 101 and one side of the second frame 102. As shown in FIG. 7 (a), the elastic spring is positioned in a state of being compressed between the first frame 101 and the second frame 102 in the retracted state. A pair of the elastic parts 210 may be disposed on both sides to provide a symmetrical force in the third direction.

When the fastened state of the locking member (device) 125 is released, as shown in FIG. 7 (b), the elastic part 210 is tensioned and provides a force for pushing the second frame 102 to space that the second frame 102 and the first frame 101 apart from each other. Although the elastic part 210 is illustrated as coupled to the first frame 101 in the drawing, the clastic part 210 may be coupled to the second frame 102 as well.

As shown in FIG. 7 (b), a user may pull the second frame 102 having moved by a predetermined distance d1 by the elasticity of the elastic part 210 to switch the second frame 102 to an extended state shown in FIG. 7 (c).

When the second frame 102 is moved by the elastic part 210 or when the user pulls the second frame 102 in the first direction or pushes the second frame 102 in the second direction, if the second frame 102 is moved to easily, the frame structure of the mobile terminal 100 may be damaged.

Accordingly, a frictional force may be applied between the second frame 102 and the first frame 101 to move at an appropriate speed. The mobile terminal 100 of the present disclosure may include a damping structure for adjusting a sliding speed of the second frame 102.

Referring to FIG. 7, a damper and the second frame 102 coupled to the first frame 101 may include a damping strip 222 extending in the first direction. The damper provides frictional force upon contact with the damping strip 222. However, when the damper or the damping strip 222 is worn out, a problem occurs in durability, and noise caused by friction may be generated, and thus the damper may use a rotatable rotary damper 221.

The rotary damper 221 may be rotatably coupled to the first frame 101, and may adjust a damping effect according to a coupling force with the first frame 101. That is, when the coupling force is large, a greater force should be applied for rotation, and thus a user should provide a greater force to slide and move the second frame 102.

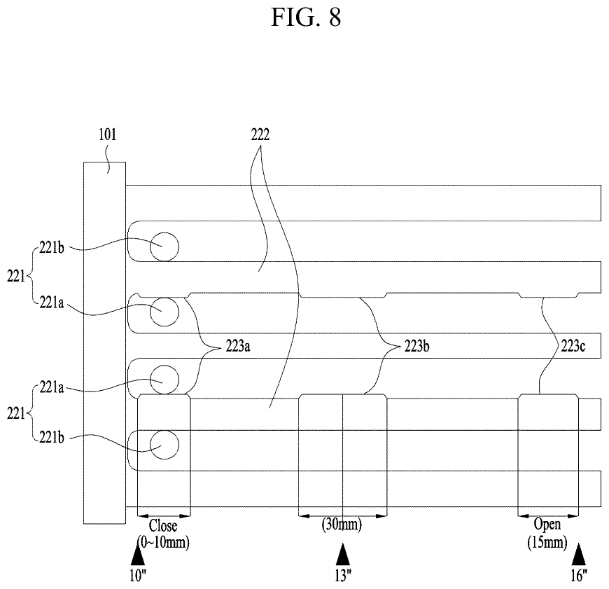

FIG. 8 is a diagram illustrating a damping structure of the mobile terminal 100 according to an embodiment, which may include a first rotary damper 221a positioned in a third direction of the damping strip 222 and a second rotary damper 221b positioned in a fourth direction opposite to the third direction.

The damping strip 222 may include a contact protrusion 223 located in the third direction toward the first rotary damper 221a. A portion where the contact protrusion 223 is formed is a deceleration section, and the contact protrusion 223 may be formed near a position at which the second frame 102 is fixed.

The damping strip 222 may reduce a slide speed of the second frame 102, such as a brake, before reaching a position where the damping strip 222 should stop by being in contact with the first rotary damper 221a in the contact protrusion 223 only.

The contact protrusion 223 may be formed in each of a section 223a before reaching a retracted state 10″ and a section 223c before reaching a second extended state 13″. Since it may switch to the first extended state from the retracted state or the second extended state, the first extended state may include the contact protrusion 223 extending in a predetermined section 223b at both sides of the fixed position 13″.

The contact protrusion 223 in the retracted state may attenuate the elastic force of the elastic part 210, thereby preventing the second frame 102 from coming out excessively.

In addition to the deceleration section, an acceleration section may further include a second rotary damper 221b in contact with the damping strip 222 so that the second frame 102 moves at an appropriate speed. The second rotary damper 221b may contact the fourth direction of the damping strip 222, and the second rotary damper 221b may maintain a contact state with the damping strip 222 throughout the sliding section of the second frame 102.

The first rotary damper 221a and the second rotary damper 221b may be disposed in a manner of facing each other on left and right sides to hold the damping strip 222, thereby improving a damping effect.

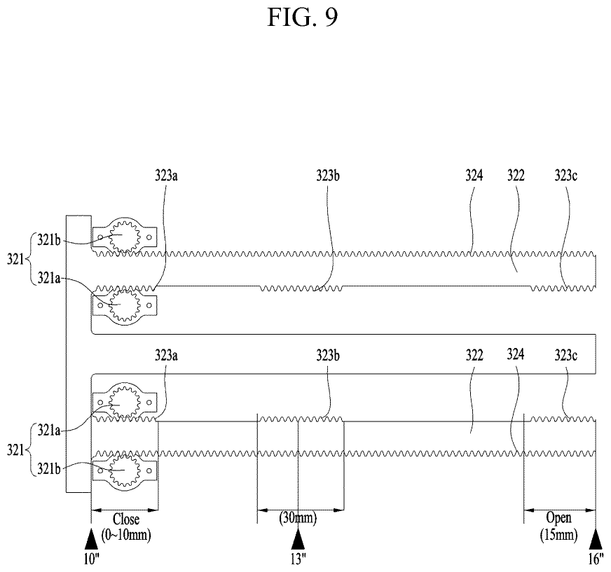

FIG. 9 is a diagram illustrating a damping structure of the mobile terminal 100 according to another embodiment. A damper may use a pinion gear 321 as well as the circular rotary damper 221, and the damping strip 222 may also use a rack gear 322 including linear sawteeth engaged with the teeth of the pinion gear 321.

The linear sawteeth of the rack gear 322 may include first linear sawteeth 223a, 223b, and 223c positioned in the third direction and second linear sawteeth 224 positioned in the fourth direction, and the first linear sawteeth 223a, 223b, and 223c may be located only at the contact protrusion 323.

The pinion gear 321 may include a first pinion gear 321a positioned in the third direction of the rack gear 322 and a second pinion gear 321b positioned in the fourth direction.

As in the above-described embodiment, the pinion gear 321 may rotate by engaging with the linear sawteeth when the rack gear 322 moves, just like the damping strip 222 rotates the rotary damper 221 by moving in response to the movement of the second frame 102.

A damping effect may be adjusted by controlling the rotational speed of the rotary damper 221 and the pinion gear 321. For example, the first rotary damper 221a of a specification of 100 gf-cm/90 rpm may be used, and the second rotary damper 221b of a specification of 200 gf-cm/90 rpm may be used.

The overall speed of the second frame 102 is adjusted by using the strength of the second rotary damper 221b greater than that of the first rotary damper 221a, and a user may recognize a stopping section by damping in a manner of adding ½ force in the retracted state, the first extended state, and the second extended state.

The mobile terminal 100 of the present disclosure may adjust the size of a screen as necessary, thereby satisfying both portability and usability.

In addition, the mobile terminal of the present disclosure may provide the mobile terminal 100 capable of manually extending and retracting the size of the display 151.

In addition, the mobile terminal of the present disclosure may stably slide and move by adjusting a speed at a position corresponding to a designated inch when the size of the display 151 is manually extended/retracted.

In addition, the elasticity of the elastic part 210 may be used to assist the force during extension, and the first frame 101 and the second frame 102 may be stably fastened without colliding during retraction.

The foregoing detailed description should not be construed as being limited in all aspects and should be considered to be illustrative. The scope of the present disclosure should be determined by the reasonable interpretation of the appended claims, and all changes within the equivalent scope of the present disclosure are included in the scope of the disclosure.

What is claimed is:

1. mobile terminal, comprising:
a first frame;
a second frame coupled to the first frame to slide in a first direction or a second direction opposite to the first direction; and
a damper coupled to the first frame,
wherein the second frame comprises a damping strip extending in the first direction and
wherein the damping strip contacts the damper in a partial section at least when the second frame slides.

2. The mobile terminal of claim 1, wherein the damper comprises a rotary damper rotatably coupled to the first frame and wherein the damper rotates according to a sliding movement of the first frame when contacting the damping strip.

3. The mobile terminal of claim 2, the damping strip comprising:
a deceleration section having a contact protrusion protruding in a third direction vertical to the first direction; and
an acceleration section having the contact protrusion not formed therein,
wherein the rotary damper comprises a first rotary damper located in the third direction of the damping strip, spaced apart from the damping strip in the acceleration section, and rotating by contacting the contact protrusion in the deceleration section.

4. The mobile terminal of claim 3, wherein the rotary damper comprises a second rotary damper positioned in a fourth direction opposite to the third direction of the damping strip and wherein the second rotary damper maintains a contact state with the damping strip when the second frame slides.

5. The mobile terminal of claim 3, wherein the first rotary damper comprises a first pinion gear having sawteeth formed on an outer circumferential surface thereof and wherein the damping strip comprises a rack gear having first linear sawteeth formed at a position related to the contact protrusion to engage with the sawteeth of the pinion gear.

6. The mobile terminal of claim 5, wherein the rack gear comprises second linear sawteeth continuously formed in a fourth direction opposite to the third direction and wherein the pinion gear comprises a second pinion gear positioned in the fourth direction of the rack gear to rotate by engaging with the second linear sawteeth.

7. The mobile terminal of claim 3, wherein the deceleration section comprises a position having the second frame fixed thereat.

8. The mobile terminal of claim 1, comprising:
a locking device configured to fix a first state of a maximum overlapping area between the second frame and the first frame; and
an elastic part located at one side of the first frame or the second frame to be compressed in the first state or extended upon releasing the locking device.

9. The mobile terminal of claim 8, the locking device comprising:
a first latch part positioned in the first frame;
a second latch part positioned in the second frame to engage with the first latch part; and
an unlock button exposed to an outside of the first frame to separate the first latch part from the second latch part.

10. The mobile terminal of claim 1, comprising a flexible display having a fixed region coupled to the first frame and a variable region located in the first direction of the fixed region and extending in a rear direction while surrounding the second frame,
wherein an area of the variable region located on a front surface varies depending on a position of the second frame.
